(19) United States
(12) Patent Application Publication
(10) Pub. No.: US 2023/0343254 A1
(43) Pub. Date: Oct. 26, 2023

(54) METHODS FOR ADJUSTING DISPLAY ENGINE PERFORMANCE PROFILES

(71) Applicant: Microsoft Technology Licensing, LLC, Redmond, WA (US)

(72) Inventors: Dmitriy CHURIN, Redmond, WA (US); Dmitry RESHIDKO, Sammamish, WA (US); Parry Byron JOHNSON, Redmond, WA (US); Fei CHEN, Woodinville, WA (US); Sean Patrick DEVER, Medina, WA (US)

(73) Assignee: Microsoft Technology Licensing, LLC, Redmond, WA (US)

(21) Appl. No.: 17/660,816

(22) Filed: Apr. 26, 2022

(51) Int. Cl. G09G 3/00; G02B 27/01

(52) U.S. Cl. CPC G09G 3/001; G02B 27/0172; G09G 2320/041; G09G 2320/0693; G09G 2360/141; G09G 2360/145; G09G 2320/08; G09G 2320/0666; G09G 2320/0233; G09G 2320/0242; G09G 2330/021; G09G 2320/043; G02B 2027/0178

(57) ABSTRACT

A system is presented for a display engine. An optical imaging pathway comprises at least a selectively reflective image forming device. An illumination beam pathway comprises an optical source cluster including one or more optical sources, optical componentry configured to generate uniform illumination of the selectively reflective image forming device, and one or more photodiodes positioned to capture light reflected off the selectively reflective image forming device. A controller is configured to command the selectively reflective image forming device to operate with a predetermined reflectivity. While the selectively reflective image forming device is operating with the predetermined reflectivity, the optical source is commanded to emit a pulse of light and the one or more photodiodes are read out. A performance profile of one or more of the optical sources and the selectively reflective image forming device is adjusted based on the photodiode readout.

### BACKGROUND

A near-eye display system may generate images by illuminating a spatial light modulator using light emitting diodes (LEDs). Example spatial light modulators include liquid crystal on silicon (LCOS) displays and digital micromirror (DMD) displays. Such display systems may be incorporated into head-mounted displays for projecting augmented reality images into a user's natural field-of-view. However, LEDs are highly sensitive to applied power and local temperature. As such, unless corrective feedback systems are implemented output power may drift over usage time, and output wavelength can drift over temperature and current settings. Spatial light modulator reflectivity is also prone to drifting due to applied power and local temperature, which can result in sub-optimal performance characteristics.

As such, if a user wearing the near-eye display system moves from one ambient temperature to another (e.g., indoors to outdoors) and/or the display system heats up over operating time, or the display system ages, or battery power wanes, maintaining the same performance profile can cause changes in the output imagery. For example, color profiles may appear altered the display may be dimmed, etc. In general, performance is monitored behind a dielectric coating which requires substantial calibration for each consumer unit, adding significant manufacturing costs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A system is presented for a display engine. An optical imaging pathway comprises at least a selectively reflective image forming device. An illumination beam pathway comprises an optical source cluster including one or more optical sources, optical componentry configured to generate uniform illumination of the selectively reflective image forming device, and one or more photodiodes positioned to capture light reflected off the selectively reflective image forming device. A controller is configured to command the selectively reflective image forming device to operate with a predetermined reflectivity. While the selectively reflective image forming device is operating with the predetermined reflectivity, the optical source is commanded to emit a pulse of light and the one or more photodiodes are read out. A performance profile of one or more of the optical sources and the selectively reflective image forming device is adjusted based on the photodiode readout.

### BRIEF DESCRIPTION OF THE DRAWINGS

FIG. 1 shows an example head-mounted display device.

FIG. 2 schematically shows an example near-eye display.

FIG. 3 schematically shows an example display engine.

FIG. 4 schematically shows an example display engine comprising a fold mirror.

FIG. 5 shows an example method for adjusting a performance profile of a display engine.

FIG. 6 schematically shows a workflow for determining a wavelength of an LED.

FIG. 7 schematically shows a process flow for determining a wavelength of an LED based at least on the readout of a photodiode.

FIG. 8 shows an example method for adjusting the performance profile of an optical source of a near-eye display.

FIG. 9 schematically shows optical pathways for a near-eye display with a selectively reflective image forming device commanded to display a black frame.

FIG. 10 shows an example method for adjusting a performance profile of a selectively reflective image forming device of a near-eye display.

FIG. 11 schematically shows optical pathways for a near-eye display with a selectively reflective image forming device commanded to display a white frame.

FIG. 12 schematically shows an example computing system.

### DETAILED DESCRIPTION

Head-mounted displays (HMDs), particularly those with augmented reality (AR) functions, rely upon display engines that are highly efficient, compact, and at least partially transparent. One popular choice for such a display engine includes an LCOS or DMD based imaging pathway optically coupled to an LED based illumination beam pathway. Such technologies provide outstanding brightness and energy efficiency. Brightness is especially important in AR modes, where the display image may be viewed against a background of real, potentially sunlit imagery. Energy efficiency is particularly important for battery-powered devices.

However, the optical power of the LEDs, and thus the output wavelength of those LEDs, can change over time and with varied temperature. This may occur, for example, when a user moves from one ambient temperature to another (e.g., from inside to outside) and/or when the HMD heats up after operating for a duration. This will affect the display quality, both in terms of uniformity of brightness and color consistency. As such, a system for reliable tracking and adjusting of the LED power is needed to further increase image quality and correctly display true colors for peak user experience.

Existing solutions for tracking LED power in HMDs are typically based on the beam pickup from the main illumination beam pathway. This may be accomplished by detecting leakage of illumination light from a reflective component of the illumination beam path, such as a fold mirror or a birdbath mirror. As an example, a dielectric coating may be applied to one of the reflective surfaces, whereby a small portion of the illumination light will leak through and hit a photodiode (PD) that is placed on the back side of the reflective component. By design, the coating may allow a percentage (e.g., 1-2%) of incident light to leak through the coating and fall onto the PD. Such coatings generally have significant modulation with regards to the wavelength of the illumination light. As such, any shift in LED wavelength may be observed as a change in power. Unless the coating and the LED wavelength shifts are known and characterized, this technique will inaccurately measure the LED power. Such characterization involved tedious and expensive calibration procedures that are not normally benchmarked for a consumer device. Alternatively, the LED power may be measured behind the optical combiner used to merge the red, green, and blue LED beams of an optical cluster. However, such a method is extremely sensitive to any wavelength shift of the LED due to the nature of the combiner coating.

As such, a method for an accurate LED power feedback is needed that will not add significant calibration time during manufacturing. Further, the reflectivity of LCOS and DMD devices can also change over time and due to operating conditions. If not properly calibrated, their performance may become sub-optimal in terms of efficiency and total performance.

Herein, systems and methods are presented for calibrating performance of both an illumination beam pathway comprising a plurality of optical sources and an optical imaging pathway including a selectively reflective image forming device. One or more photodiodes may be positioned so as to capture light reflected off of the selectively reflective image forming device. By commanding the selectively reflective image forming device to operate with a predetermined reflectivity, and commanding each optical source to emit light pulses, the output power of the optical source and the reflectivity of the selectively reflective image forming device may be determined based on a readout of the photodiodes. The performance profile of the optical source and selectively reflective image forming device may then be adjusted accordingly.

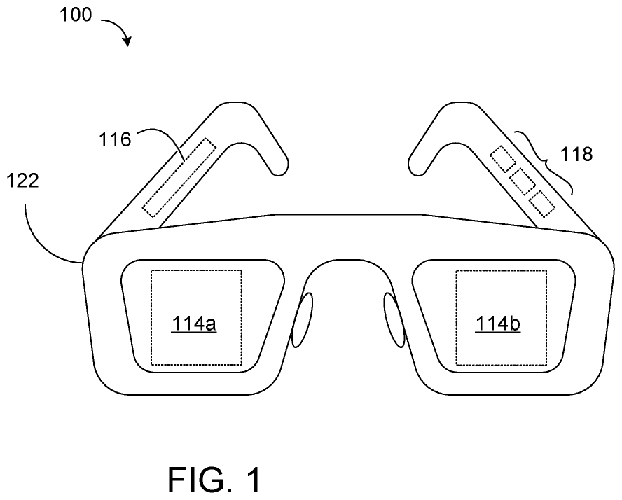

FIG. 1 shows an example HMD device 100 in one embodiment. HMD device 100 may closely resemble an ordinary pair of eyeglasses or sunglasses, that includes near-eye display systems 114A and 114B. Near-eye display system 114A is arranged in front of the right eye; near-eye display system 114B is arranged in front of the left eye. HMD device further includes controller 116 and sensors 118. Controller 116 is a microcomputer operatively coupled to both near-eye display systems 114A and 114B and to sensors 118. HMD device 100 also includes wearable mount 122, which positions the near-eye display systems a short distance in front of the wearer's eyes. In the embodiment of FIG. 1, the wearable mount takes the form of conventional eyeglass frames.

Sensors 118 may be arranged in any suitable location in HMD device 100. They may include a gyroscope or other inertial sensor, a global-positioning system (GPS) receiver, photodiodes, ambient sensor cameras, and/or a barometric pressure sensor configured for altimetry. Sensors 118 may thus provide data on the wearer's location or orientation. From the integrated responses of sensors 118, controller 116 may track the movement of HMD device 100 within the wearer's environment.

In one embodiment, sensors 118 may include an eye-tracker—i.e., a sensor configured to detect an ocular state of the wearer of HMD device 100. The eye tracker may locate a line of sight of the wearer, measure an extent of iris closure, etc. If two eye trackers are included, one for each eye, then the two may be used together to determine the wearer's focal plane based on the point of convergence of the lines of sight of the wearer's left and right eyes. This information may be used by controller 116 for placement of a computer-generated display image, for example.

In the illustrated embodiment, each of near-eye display systems 114A and 114B is at least partly transparent, to provide a substantially unobstructed field of view in which the wearer can directly observe his physical surroundings. Each of near-eye display systems 114A and 114B is configured to present, in the same field of view, a computer-generated display image. Controller 116 may control the internal componentry of near-eye display systems 114A and 114B in order to form the desired display images. In one embodiment, controller 116 may cause near-eye display systems 114A and 114B to display the same image concurrently, so that the wearer's right and left eyes receive the same image at the same time. In another embodiment, near-eye display systems 114A and 114B may project somewhat different images concurrently, so that the wearer perceives a stereoscopic, i.e., three-dimensional image. In one scenario, the computer-generated display image and various real images of objects sighted through near-eye display systems 114A and 114B may occupy different focal planes. Accordingly, the wearer observing a real-world object may have to shift his or her corneal focus in order to resolve the display image. In other scenarios, the display image and at least one real image may share a common focal plane.

In the HMD devices disclosed herein, near-eye display systems 114A and 114B may also be configured to acquire video of the surroundings sighted by the wearer. The video may include depth video. It may be used to establish the wearer's location, what the wearer sees, etc. The video acquired by near-eye display system 114A and 114B may be received in controller 116, and controller 116 may be configured to process the video received. To this end, near-eye display systems 114A and 114B may include a camera. The optical axis of the camera may be aligned parallel to a line of sight of the wearer of HMD device 100, such that the camera acquires video of the external imagery sighted by the wearer. As HMD device 100 may include two near-eye display systems—one for each eye—it may also include two cameras. More generally, the nature and number of the cameras may differ in the various embodiments of this disclosure. One or more cameras may be configured to provide video from which a time-resolved sequence of three-dimensional depth maps is obtained via downstream processing.

No aspect of FIG. 1 is intended to be limiting in any sense, for numerous variants are contemplated as well. In some embodiments, for example, a vision system separate from near-eye display systems 114A and 114B may be used to acquire video of what the wearer sees. In some embodiments, a binocular near-eye display system extending over both eyes may be used instead of the monocular near-eye display systems shown in the drawings. Likewise, an HMD device may include a binocular eye tracker. In some embodiments, an eye tracker and near-eye display system may be integrated together, and may share one or more optics.

The HMD devices disclosed herein may be used to support a virtual-reality (VR) or AR environment for one or more participants. A realistic AR experience may be achieved with each AR participant viewing his environment naturally, through passive optics of the HMD device. Computer-generated imagery, meanwhile, may be projected into the same field of view in which the real-world imagery is received. Imagery from both sources may appear to share the same physical space.

The controller in the HMD device may be configured to run one or more computer programs that support the VR or AR environment. In some embodiments, some computer programs may run on an HMD device, and others may run on an external computer accessible to the HMD device via one or more wired or wireless communication links. Accordingly, the HMD device may include suitable wireless componentry, such as Wi-Fi.

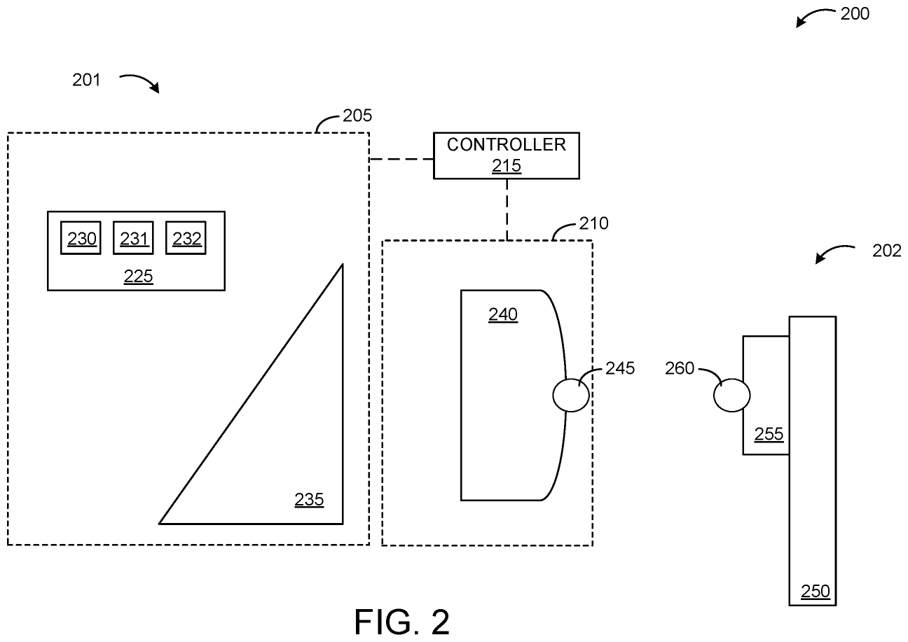

FIG. 2 shows an example near-eye display system 200 that includes a display engine 201 and projection optics 202. Display engine 201 includes an illumination beam pathway 205 and an optical imaging pathway 210. Controller 215 may be operatively coupled to active components of illumination beam pathway 205 and optical imaging pathway 210. For example, controller 215 may provide suitable control signals that, cause the desired display image to be formed. In some examples, controller 215 may receive signals from one or more sensors of illumination beam pathway 205 and/or optical imaging pathway 210.

Illumination beam pathway 205 may include an optical source cluster 225 comprising one or more optical sources. In this example, three optical sources (230, 231, and 232) are shown, though optical source cluster 225 may include more or fewer optical sources depending on the configuration of illumination beam pathway 205. For example, optical source cluster 225 may include a white-light source, such as a white light-emitting diode (LED) or laser. Additionally or alternatively, optical sources 230, 231, and 232 may include a red emitter (e.g., LED), a green emitter, and a blue emitter, all of suitably narrow wavelength bands. In some examples, each optical source is fired in sequence, synchronized to receipt of control data from controller 215 corresponding to the component image of the associated color. Although shown with all optical sources in neighboring locations, the optical sources within optical cluster 225 may alternatively not be collocated.

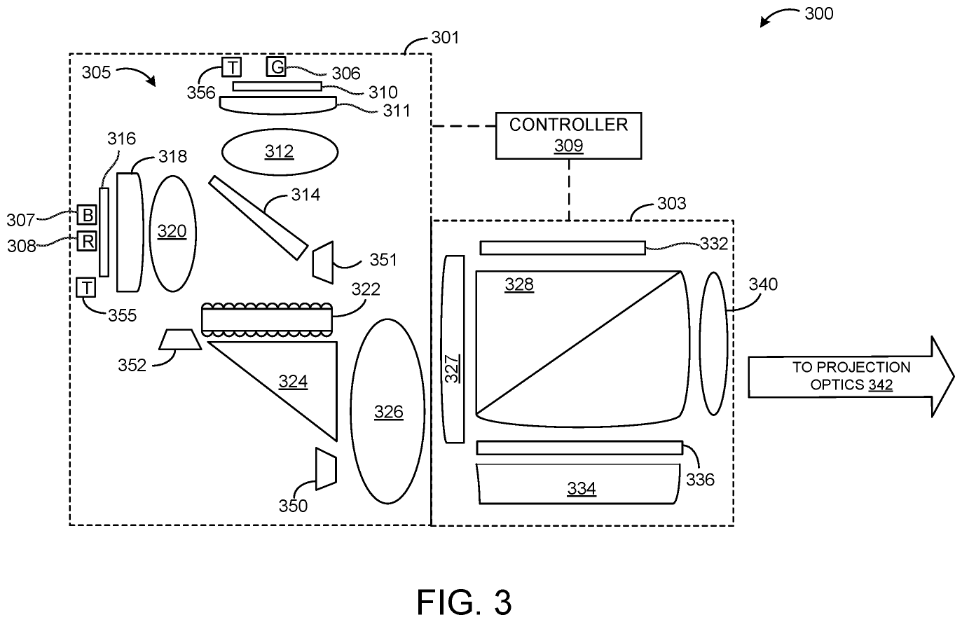

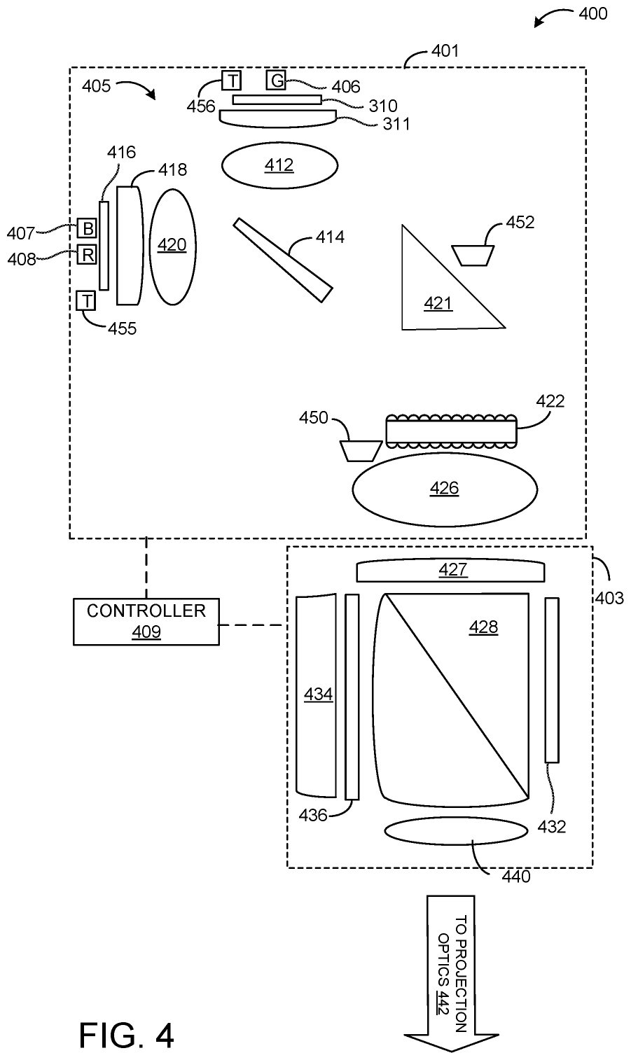

Illumination beam pathway 205 may further include optical componentry 235 that may be configured to generate uniform illumination of a selectively reflective image forming device 240 contained within optical imaging pathway 210. For example, the angle of incidence may be based at least in part on image data received by the controller for reproduction. The wavelength of light of each optical source may influence the selected angle of incidence, for examples. As an example, an illuminator may further comprise an optic suitable for collimating the emission of the white-light source and directing the emission into the image former, or for combining the emissions of multiple (e.g., RGB) color emitters. As will be described with regards to FIGS. 3 and 4, reflective and/or refractive optical components may be used to allow illumination beam pathway 205 and optical imaging pathway 210 to be positioned in a non-telecentric fashion. This may both reduce problems due to reflection and glare, and allow for functional configurations that accommodate other componentry.

Optical imaging pathway 210 is configured to form a display image and to release the display image through output pupil 245. Selectively reflective image forming device 240 may be a reflective LCOS or DMD device, or other suitable device wherein an angle of reflectivity can be selectively adjusted. As an example, in the fully on state of a pixel, the reflective element may be deflected such that the light incident on that element is reflected into output pupil 245. In the fully off state, the mirror element may be deflected such that the incident light is reflected away from output pupil 245, such as back to illumination beam pathway 205.

In some examples, an LCOS array may be utilized in which polarization-rotating liquid-crystal is situated on a rectangular array of passivated, highly-reflective pixel elements. The elements themselves may be fabricated on a silicon chip, which electrically addresses each of the elements, causing them to rotate the polarization plane of the light reflected therefrom. An LCOS array is a regular, two-dimensional array of liquid-crystal elements. In some examples, the elements may share an optically transparent front electrode while being provided each with an individually addressable, reflective back electrode. In other examples, both electrodes are addressable for each pixel. Electrical bias applied to an element of the array changes the alignment of the liquid crystal therein, enabling that element to function as a polarizing filter to illumination reflecting from the back electrode. In this manner, light of a controlled polarization state emerges from each pixel element. The undesired polarization component is removed as it passes through a front polarizer common to all elements of the array. This action converts the encoded polarization-state of the light from each element into a corresponding reflected intensity from that element. A suitable array driver provides control data, which determines the level of bias of each element and thereby defines the image reflected from the array.

In embodiments where a DMD array is implemented, an individually deflectable mirror element may be provided for each pixel of the display image. In other embodiments, selectively reflective image forming device 240 may take the form of a ferroelectric LCOS (FLCOS) array having decreased polarization-state switching latency, or a holographic spatial light modulator (SLM), as examples. Selectively reflective image forming device 240 may be a compact component characterized by a relatively small output pupil 245. The diameter of the exit pupil of the image former may be 5 millimeters (mm), in one example.

Optical imaging pathway 210 may be offset from the field of view of the user of near-eye display system 200. In such a configuration, optical imaging pathway 210 does not obstruct the wearer's view of external imagery transmitted through near-eye display system 200. Accordingly, projection optics 202 of near-eye display system 200 also includes waveguide 250, an optic configured to receive the display image and to shift the display image into the wearer's field of view. Waveguide 250 may be substantially transparent to external imagery received normal to its front surface. Thus, the waveguide may be positioned in front of the eye of the HMD-device wearer without obstructing the wearer's view of the external imagery. Light emitted from optical imaging pathway 210 via output pupil 245 may be directed to waveguide 250 via incoupler 255 at input pupil 260. In some examples, input pupil 260 may be equally sized to output pupil 245, but may alternatively have a larger aperture.

As a more specific example of optics for a near-eye display, FIG. 3 shows display engine 300 which includes an illumination beam pathway 301 and an optical imaging pathway 303. Illumination beam pathway 301 comprises an optical source cluster 305 that includes green optical source (e.g. a green LED) 306, blue optical source (e.g. a blue LED) 307, and red optical source (e.g. a red LED) 308, controlled by controller 309. Green light from the green optical source 306 passes through optics 310, 311, and 312 (e.g., one or more lenses, combiners, collimators, and/or other suitable components) to a beam combiner 314. Similarly, light from blue optical source 307 and red optical source 308 passes through optics 316, 318, 320 to beam combiner 314. Beam combiner 314 combines the red, green and blue light into a single beam, and directs the beam to a microlens array (MLA) 322. Microlens array 322 homogenizes the single light beam, and also shapes the light beam at least in part to more uniformly provide illumination to downstream optical components and to remove artifacts. Microlens array 322 outputs the light to a prism 324 that directs the light to a lens 326. In some examples, prism 324 allows for non-telecentric illumination of optical imaging pathway 303, tilting the output of the illumination sources. Some embodiments may not include prism 324, rather having the optical axis of the illumination light mismatch with lens 326. In other examples, normal illumination may be used, other the entire illumination pathway may be tilted with regard to lens 326. Lens 326 then directs the light to optical imaging pathway 303.

A pre-polarizer 327 may be situated optically in front of polarizing beam splitter (PBS) 328 of optical imaging pathway 303, so that light entering PBS 328 is polarized. PBS 328 then directs the light toward a selectively reflective image forming device 332, which is controlled by a controller 309 to form an image. A lens (not shown) may optionally be positioned between PBS 328 and selectively reflective image forming device 332. Image light from selectively reflective image forming device 332 passes back through lens 330 and polarizing beam splitter 328, reflects from mirror 334 (additionally or alternatively incorporated in polarizing beam splitter 328), and then off quarter-wave plate 336. Light directed from quarter-wave plate 336 then passes through lens 340 (additionally or alternatively incorporated in polarizing beam splitter 328) toward other projection optics 342 (e.g., a waveguide and/or lens(es)) for display.

Light angular spatial distribution may be optimized with lens 326, lens 330 may be used to optimize light angle distribution of the output light. Such a combination of lenses acts to uniformly spread the light across selectively reflective image forming device 332.

When selectively reflective image forming device 332 is turned on, it may act as a quarter waveplate per individual pixel, altering the polarization of the reflected light. As such, rather than reflecting back to illumination beam pathway 301, the light passes through polarizing beam splitter 328, then reflects off of mirror 334. Quarter-wave plate 336 changes the polarization of the light again so it is reflected to lens 340, rather than going back through polarizing beam splitter 328.

Accordingly, one more sensors, such as photodiodes, may be included in illumination beam pathway 301 to characterize current aspects of one or more of the optical components included in display engine 300. As an example, PD 350 is positioned to capture light that is reflected from selectively reflective image forming device 332 back into illumination beam pathway 301. For example, when selectively reflective image forming device 332 is turned off, a significant amount of light is returned to illumination beam pathway 301 because the light is not polarized in a way to pass through polarizing beam splitter 328. When selectively reflective image forming device 332 is turned on, most, but not all reflected light passes through polarizing beam splitter 328, as the selectively reflective image forming device 332 is less than 100% effective.

In some examples, such as for photodiode 350, one or more photodiodes are not positioned within a beam pathway of the one or more optical sources. As such, the photodiode does not absorb any light that would otherwise be intended to output to projection optics 342. This may be conveniently implemented in embodiments such as display engine 300, wherein illumination beam pathway 301 and the optical imaging pathway 303 are non-telecentric.

Although most embodiments described herein are described with regard to a photodiode positioned at or near PD 350, this is by no means the only place a photodiode may be positioned within illumination beam pathway 301. For example, PD 352 is positioned optically next to microlens array 322, facing the optical sources. This position may enable output light from each optical source to be measured more directly. This measurement may be made without regard to wavelength, but does not measure reflection from the selectively reflective image forming device 332. PD 351 is positioned to capture light residual from the beam combiner 314, which makes it very sensitive to wavelength shift due to its coating.

In some examples, the one or more photodiodes includes two or more photodiodes with differing wavelength filters. The controller may thus be configured to determine a wavelength of each optical source based on a readout of the two or more photodiodes with differing wavelength filters when each optical source is commanded to emit a pulse of light. In some examples, ambient sensors may additionally or alternatively be used.

In some examples, one or more temperature sensors (e.g., temperature sensors 355 and 356) may additionally or alternatively be positioned in the optical source cluster 305. The controller may thus be configured to determine a wavelength of each optical source based on a readout of the one or more temperature sensors (355, 356) and LED current settings.

FIG. 4 shows an alternate configuration for a display engine 400 which includes an illumination beam pathway 401 that is offset from an optical imaging pathway 403. Illumination beam pathway 401 comprises an optical source cluster 405 that includes green optical source 406, blue optical source 407, and red optical source 408, controlled by controller 409. Green light from the green optical source 406 passes through optics 410, 411, and 412 to a beam combiner 414, while light from blue optical source 407 and red optical source 408 passes through optics 416, 418, 420 to beam combiner 414.

Beam combiner 414 combines the red, green, and blue light into a single beam, and directs the beam to a fold mirror 421, which reflects the single light beam towards MLA 422. MLA 422 outputs the light to a lens 426. Lens 426 then directs the light to optical imaging pathway 403. By using a fold or birdbath mirror the optical imaging pathway 403 may be offset from the illumination beam pathway 401. Pre-polarizer 427 it situated optically in front of polarizing beam splitter 428 of optical imaging pathway 303, so that light entering PBS 328 is polarized. PBS 428 of optical imaging pathway 403 directs the light through optional lens 430 and toward a selectively reflective image forming device 432, which is controlled by a controller 409 to form an image. As per optical imaging pathway 303, optical imaging pathway 403 further includes mirror 434, quarter-wave plate 436, and lens 340, which focuses light towards projection optics 442 for display.

One more sensors, such as photodiodes, may be included in illumination beam pathway 401 to characterize current aspects of one or more of the optical components included in display engine 300. As an example, PD 450 is positioned to capture light that is reflected from selectively reflective image forming device 332 back into illumination beam pathway 301. An additional or alternative photodiode 452 may be positioned optically behind fold mirror 421. The output of photodiode 452 may be sensitive to the coating of fold mirror 421 as well as to any shifts in wavelength to light output by optical sources 406, 407, and 408. By positioning PD 452 facing towards lens 426, both light from the optical sources and light reflected off selectively reflective image forming device 432 may be captured. In some examples, one or more temperature sensors (e.g., temperature sensors 455 and 456) may additionally or alternatively be positioned in the optical source cluster 405.

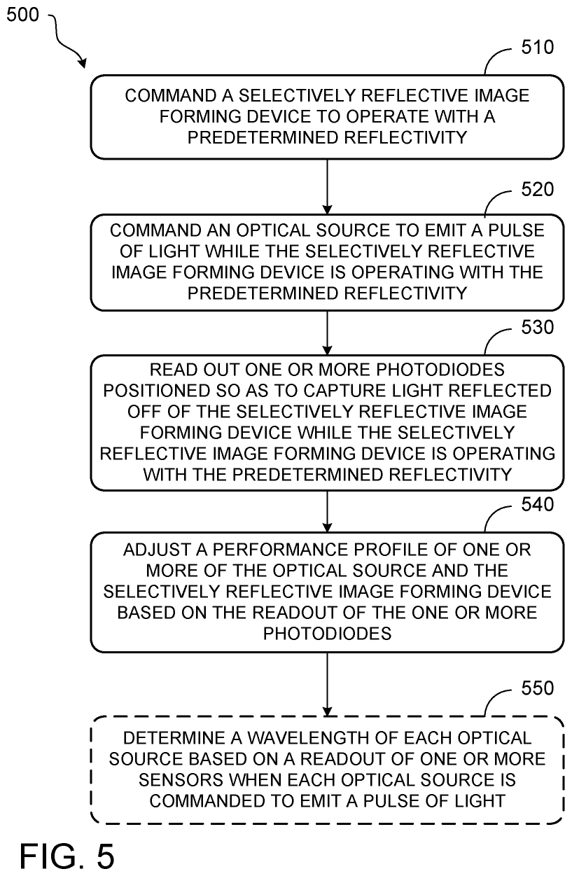

Such photodiodes and temperature sensors may be utilized to characterize and adjust performance characteristics of the optical sources and selectively reflective image forming devices of a display engine. FIG. 5 shows a flow chart for an example method 500 for calibrating a near-eye display device. Method 500 may be applied to display devices comprising display engines, such as those described with regard to FIGS. 2-4. In particular, method 500 may be carried out by a controller of a device that includes an optical imaging pathway comprising at least a selectively reflective image forming device, and an illumination beam pathway, comprising an optical source cluster including one or more optical sources, optical componentry configured to generate uniform illumination of the selectively reflective image forming device, and one or more photodiodes positioned so as to capture light reflected off of the selectively reflective image forming device. Method 500 may be included as part of a scheduled calibration, and/or performed in response to operating conditions. Method 500 may be performed by a controller, such as controllers 116, 215, 309, and 409.

At 510 method 500 includes, commanding the selectively reflective image forming device to operate with a predetermined reflectivity. The predetermined reflectivity may be a reflectivity with respect to one or more photodiodes. In other words, based on the relative positioning of each photodiode, a first predetermined reflectivity of the selectively reflective image forming device may be commanded so as to reflect light away from the photodiode. A second predetermined reflectivity of the selectively reflective image forming device may be commanded so as to reflect light toward the photodiode. Additional predetermined reflectivities may be commanded when multiple photodiodes are included, for example, to generate an expected ratio across photodiodes. Additionally or alternatively, the predetermined reflectivity may be commanded to generate an expected ratio of light reflected off of the selectively reflective image forming device to light received directly from an optical source, be it at the same photodiode or across multiple photodiodes.

At 520, method 500 includes commanding the optical source to emit a pulse of light while the selectively reflective image forming device is operating with the predetermined reflectivity. The power and pulse-width of the command may be predetermined, or may be based on operating conditions. For example, the optical source may be commanded to emit a pulse of light equivalent to a single frame of display content (e.g., 1/30 of a second for a 30 fps display). This may allow the controller to establish an expected reading for each photodiode based on pulse characteristics and predetermined reflectivity.

At 530, method 500 includes reading out the one or more photodiodes while the selectively reflective image forming device is operating with the predetermined reflectivity. The readout may be compared to an expected readout, compared to other photodiodes in the system being read out, compared to readouts from other sensors over the same pulse width, etc. In some examples, two or more readouts may be performed over time to further characterize the device elements under varying conditions.

At 540, method 500 includes adjusting a performance profile of one or more of the optical source and the selectively reflective image forming device based on the readout of the one or more photodiodes. For example, the drive power of the optical source may be adjusted. In this way, the commanded wavelength and intensity of the optical source can be calibrated. Additionally or alternatively, a drive signal and/or one or more additional operating parameters of the selectively reflective image forming device may be adjusted.

Optionally at 550, method 500 includes determining a wavelength of each optical source based on a readout of one or more sensors when each optical source is commanded to emit a pulse of light. For example, one or more temperature sensors may be positioned within or proximal to the optical source cluster. The controller may be further configured to estimate, infer, and/or determine a wavelength of each optical source based on a readout of the one or more temperature sensors when each optical source is commanded to emit a pulse of light.

Additionally or alternatively, the photodiodes may include two or more photodiodes with differing wavelength filters, and the controller may be further configured to determine a wavelength of each optical source based on a readout of the two or more photodiodes with differing wavelength filters when each optical source is commanded to emit a pulse of light. By using an array of photodiodes with different color filters, direct measurement of any optical source wavelength changes may be performed.

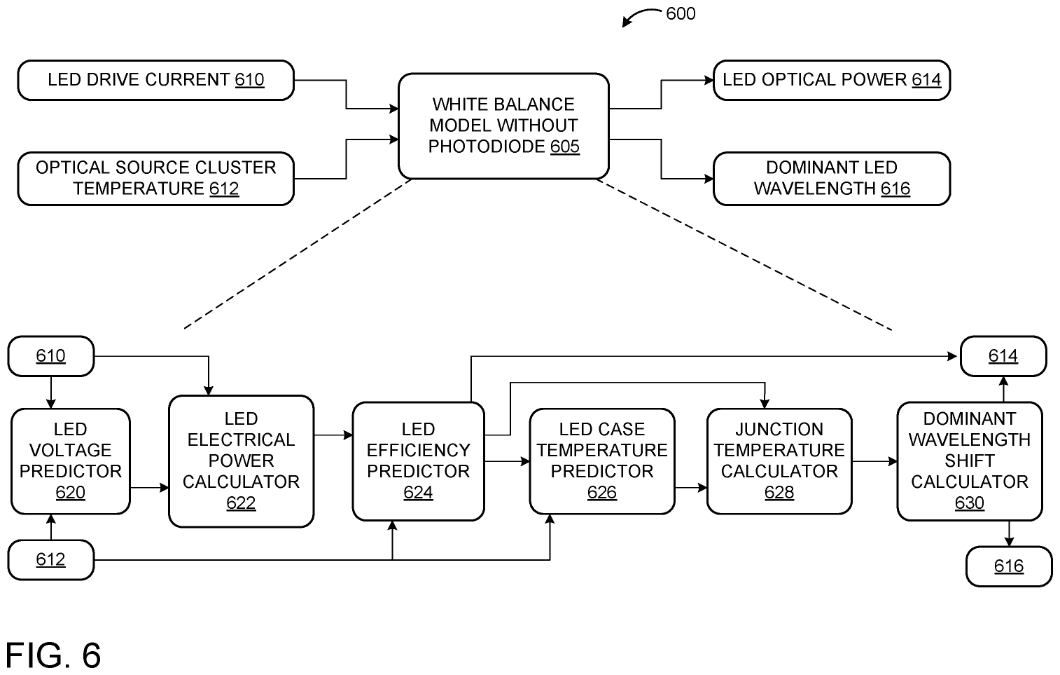

For example, FIG. 6 schematically shows a workflow 600 for determining a wavelength of an LED. Workflow 600 may comprise a white balance model 605 usable to determine LEDs of multiple wavelengths without using a readout of a photodiode. White balance model 605 may thus balance the output of such LEDs so that, when commanded on, a white frame is presented to the user. Workflow 600 may be performed by a controller, such as controllers 116, 215, 309, and 409. In a general example LED drive current 610 and a readout 612 of an optical source cluster temperature sensor (e.g., temperature sensors 355 and/or 356) are inputs to white balance model 605, which outputs an optical power 614 and a dominant LED wavelength 616 based on LED drive current 610 and a readout 612 of optical source cluster temperature sensor. White balance model 605 may operate for one or multiple LEDs, depending on the optical source configuration. A system, such as system 300, may employ one circuit deploying the white balance model for each LED in succession, or may include a dedicated circuit for each LED or each subset of LEDs.

As a non-limiting example, white balance model 605 may include an LED voltage predictor 620 configured to approximate the voltage of an LED based on LED drive current 610 and optical source cluster temperature 612. As an example, the LED voltage may be approximated using a diode model regression, but other predictive algorithms or lookup tables may additionally or alternatively be used. The predicted LED voltage and the LED drive current 610 may then be fed to an LED electrical power calculator 622, where the electrical power may be determined, such as proportionate to the product of LED current and LED voltage.

The determined LED electrical power and the optical source cluster temperature 612 may then be used as inputs to an LED efficiency predictor 624. The efficiency predictor may derive an efficiency based on previously captured data, such as from a lookup table. The LED efficiency may then be used to determine an LED thermal power and an LED optical power. The determined optical power may be output at 614. The determined LED thermal power and the optical source cluster temperature 612 may then be used as inputs to an LED case temperature predictor 626. A case temperature may be determined through any suitable means, such as using the Foster thermal model to simulate heat transfer through a semiconductor.

The predicted LED case temperature and the LED thermal power may then be used as inputs to a junction temperature calculator 628. Such junction temperatures may be empirically determined for each LED type and included in the specification datasheet for the LED. The junction temperatures may be stored in a lookup table. The determined LED junction temperature may then be used as an input to a dominant wavelength shift calculator 630. Dominant wavelength shift calculator 630 may then determine a dominant wavelength for the LED, such as through a regression on previously measured data. This determined wavelength may be output as the dominant LED wavelength 616.

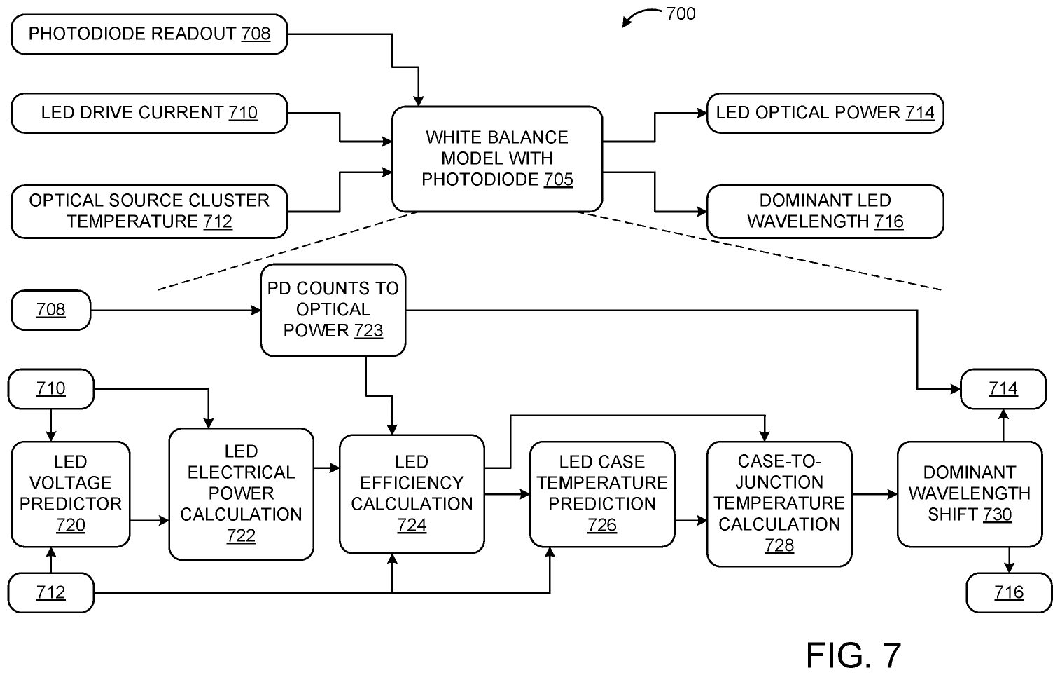

FIG. 7 schematically shows a workflow 700 for determining a wavelength of an LED based at least on a readout of a photodiode, such as photodiode 350. Workflow 700 may comprise a white balance model 705 usable to determine LEDs of multiple wavelengths. Workflow 700 may be used in addition to or as an alternative to workflow 600 for examples such as shown in FIGS. 3, and 4 where photodiodes are deployed within the illumination beam pathway. Workflow 700 may be performed by a controller, such as controllers 116, 215, 309, and 409. In a general example, photodiode readout 708, LED drive current 710, and a readout 712 of an optical source cluster temperature sensor (e.g., temperature sensors 355 and/or 356) are inputs to white balance model 705, which outputs an optical power 714 and a dominant LED wavelength 716 based on photodiode readout 708, LED drive current 710, and a readout 712 of optical source cluster temperature sensor. White balance model 705 may operate for one or multiple LEDs, depending on the optical source configuration. A system, such as system 300, may employ one circuit deploying the white balance model for each LED in succession, or may include a dedicated circuit for each LED or each subset of LEDs.

As a non-limiting example, white balance model 705 may include an LED voltage predictor 720 configured to approximate the voltage of an LED based on LED drive current 710 and optical source cluster temperature 712. As an example, the LED voltage may be approximated using a diode model regression, but other predictive algorithms or lookup tables may additionally or alternatively be used. The predicted LED voltage and the LED drive current 710 may then be fed to an LED electrical power calculator 722, where the electrical power may be determined, such as proportionate to the product of LED current and LED voltage.

Photodiode readout 708 may be used as an input to a photodiode counts to optical power calculator 723. The optical power 723 may determine the optical power directly from the photodiode readout 708 by any suitable means. The calculated optical power may then be output as LED optical power 714.

The LED optical power, the determined LED electrical power, and the optical source cluster temperature 712 may then be used as inputs to an LED efficiency calculator 724. The LED optical power may allow for the LED efficiency calculator 724 to be precisely determined, rather than by estimation based on prior calculations, as thermal power is equal to electrical power minus optical power. The LED efficiency may then be used to determine an LED thermal power and an LED optical power. The determined optical power may be output at 614. The determined LED thermal power and the optical source cluster temperature 712 may then be used as inputs to an LED case temperature predictor 726. A case temperature may be determined through any suitable means, such as using the Foster thermal model to simulate heat transfer through a semiconductor.

The predicted LED case temperature and the LED thermal power may then be used as inputs to a junction temperature calculator 728. Such junction temperatures may be empirically determined for each LED type and included in the specification datasheet for the LED. The junction temperatures may be stored in a lookup table. The determined LED junction temperature may then be used as an input to a dominant wavelength shift calculator 730. Dominant wavelength shift calculator 730 may then determine a dominant wavelength for the LED, such as through a regression on previously measured data. This determined wavelength may be output as the dominant LED wavelength 716. In this way, method 500 may be implemented so that a full set of information can be measured in the runtime for full characterization of the display engine, including optical source power, optical source wavelength, and reflectivity selectively reflective image forming device.

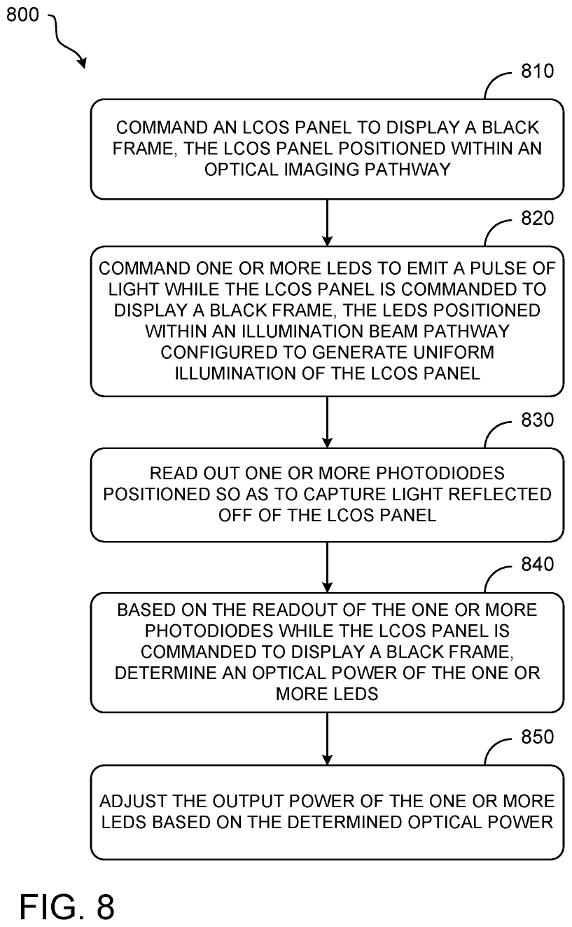

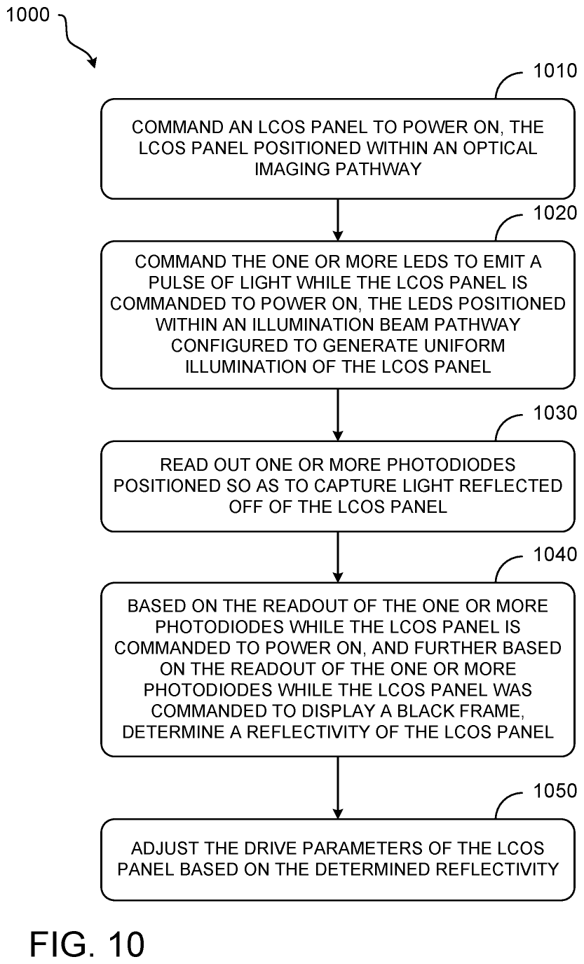

Method 500 may be implemented for more specific systems, such as display engine 300 or other systems including LED clusters and LCOS reflective image formers. For example, FIGS. 8 and 10 show two stages of an example method for near-eye display calibration that may be performed in sequence, in tandem, or independently of each other. FIG. 8 shows a flow chart for a method 800 for calibrating an optical power of one or more LEDs. By accurately calibrating each LED, more accurate colors may be presented on the display. If the measurement for one LED is off, then the wavelengths from a cluster may not combine as desired, e.g., commanded white portions of the display may have a visible tint.

Method 800 may be performed by a controller, such as controllers 116, 215, 309, and 409. Method 800 may be performed responsive to an indication to perform a first calibration step. For example, the indication to perform the first calibration step may include instructions to perform the first calibration step during a warm-up phase of the near-eye display device. Additionally or alternatively, the indication to perform the first calibration step may include instructions to perform the first calibration step in response to a threshold change in ambient temperature during an operation phase of the near-eye display device. Additionally or alternatively, the indication to perform the first calibration step includes instructions to perform the first calibration step in response to exceeding a threshold runtime during operation of the near-eye display device. In this way, the LED power may be calibrated due to changes in external temperature, ambient temperature, battery charge, scheduled maintenance, etc. As described below, method 800 may be performed while a user is viewing imagery via the near-eye display without significant disruption in the user experience.

At 810, method 800 includes commanding an LCOS panel to display a black frame, the LCOS panel positioned within an optical imaging pathway. For example, the LCOS panel may be powered off for a pre-determined duration, such as a single frame of display content. In the off conformation, the LCOS panel may reflect a majority of light back to the illumination beam pathway, with little, if any, light directed towards the projection optics of the near-eye display.

As such, commanding the LCOS panel to display a black frame may be performed while the user is viewing virtual imagery with modest impact on the user experience. As the image light may be integrated over several frames, the user may only perceive a brief period of slight display dimming, rather than a prolonged black image.

At 820, method 800 includes commanding one or more light-emitting diodes (LEDs) to emit a pulse of light while the LCOS panel is commanded to display a black frame, the LEDs positioned within an illumination beam pathway configured to generate uniform illumination of the LCOS panel. In this way, it is possible to directly measure the LED power that is reflected from the LCOS panel back to the illumination beam pathway, and thus to measure the amount of light that is incident on the LCOS panel.

At 830, method 800 includes reading out one or more photodiodes positioned so as to capture light reflected off of the LCOS panel. The wavelength of the LED may shift a few nanometers in either direction due to a change of LED junction temperature that tracks with ambient temperature, LED current, or LED duty cycle. However, the photodiode response may be set to be effectively independent of LED output wavelength within a few nanometers shift. Therefore, the photodiode may measure the actual optical power with a high degree of precision.

At 840, method 800 includes, based on the readout of the one or more photodiodes while the LCOS panel is commanded to display a black frame, determining an optical power of the one or more LEDs. The optical power may be determined empirically, and/or via a lookup table of photodiode readouts and ambient conditions. Such an approach for LED power determination is based directly on the amount of light incident on, and thus reflected off the LCOS panel, and is thus highly relevant for display calibration.

At 850, method 800 includes adjusting the output power of the LEDs based on the determined optical power. For example, the output power of one or more LEDs may be increased or decreased to balance the output of the optical cluster, so that display image brightness and colorization are generated as commanded.

This calibration procedure may be performed for different LED duty cycle settings, such as a range or duty cycle settings or across two or more discreet duty cycle settings. For example, the optical source may be commanded to emit a pulse of light over a pattern of duty cycles.

One or more photodiodes may be read out for each duty cycle in the pattern of duty cycles. An output power of the optical source may be adjusted based on the readouts of the one or more photodiodes for each duty cycle in the pattern of duty cycles. A gradient of output power and duty cycles may be leveraged to adjust output power of one or more LEDs in between calibration stages.

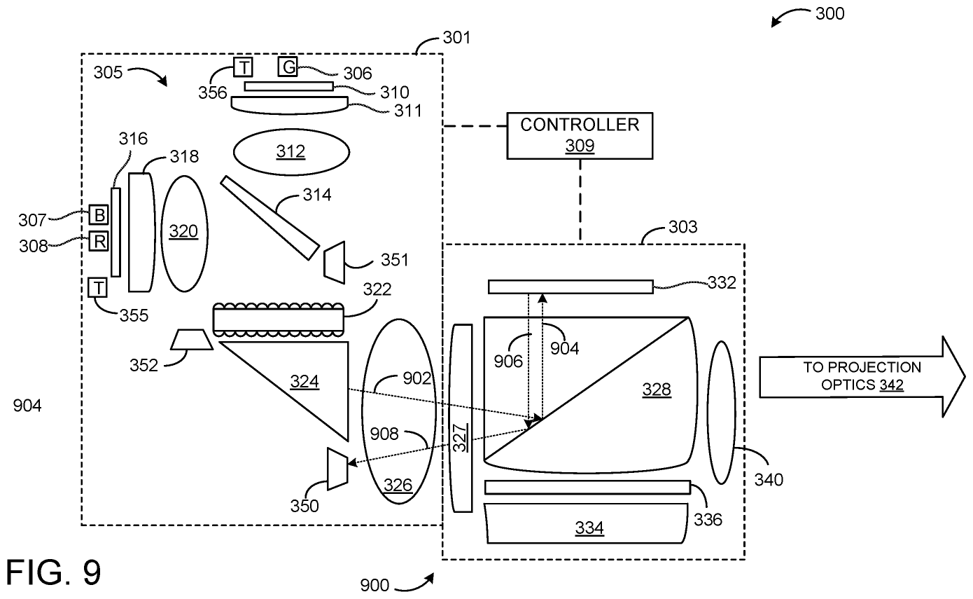

As an example, FIG. 9 shows an example scenario 900 for display engine 300 when selectively reflective image forming device 332 is turned off. Light emitted from one or more optical source is combined in beam combiner 314, then directed to prism 324 via microlens array 322. As shown by arrow 902, light emitted from prism 324 is directed to polarizing beam splitter 336 via lens 326 and pre-polarizer 327, where it is reflected towards selectively reflective image forming device 332, as shown by arrow 904. As selectively reflective image forming device 332 is off, this light does not get re-polarized. Rather, it reflects back to polarizing beam splitter 336 as shown by arrow 906. Rather than passing through polarizing beam splitter 336, the light is reflected back to the illumination beam pathway, as shown by arrow 908. As such, photodiode 350 is in position to detect this reflected light. The readout of photodiode 350 can then be used in assessing optical source power, reflectivity, and/or other parameters.

As described above, measurements taken when the selectively reflective image forming device is powered off may be combined with measurements taken when the selectively reflective image forming device is powered on to ascertain a more complete picture of display engine performance. FIG. 10 shows a flow chart for an example method 1000 for calibrating a reflectivity of a selectively reflective image forming device, such as an LCOS device as deployed in FIGS. 3 and 4. Method 1000 may be performed by a controller, such as controllers 116, 215, 309, and 409. Method 1000 may be performed responsive to an indication to perform a second calibration step. For example, the second calibration step may be performed following a first calibration step, such as method 800. The first calibration step and second calibration steps may not necessarily be performed in their entirety in that order. However, as will be described, information gathered during the first calibration step may be used to complete the second calibration step. In some examples, the indication to perform the second calibration step includes instructions to perform the second calibration step in response is performed during warm-up of the near-eye display device, in response to environmental changes in temperature, in response to device temperature or operation time, etc.

At 1010, method 1000 includes commanding an LCOS panel to display a white frame, the LCOS panel positioned within an optical imaging pathway. When the LCOS is powered on and displaying a white frame, light is sent to the user via the projection optics. However, not 100% of light is sent toward user, and significant portion of light is still reflected back to the illumination module.

At 1020, method 1000 includes commanding the one or more LEDs to emit a pulse of light while the LCOS panel is commanded to display a white frame, the LEDs positioned within an illumination beam pathway configured to generate uniform illumination of the LCOS panel. As the pulse of light will be directed to the projection optics, the user is likely to notice this calibration step. As such, method 1000 may be performed during warm-up, and/or following presentation of a calibration warning to the user. However, if the calibration is performed as a single frame, the user may only experience a brief increase in background brightness, and may thus not need an advance warning.

At 1030, method 1000 includes reading out one or more photodiodes positioned so as to capture light reflected off of the LCOS panel. In an ideal case, when the LCOS is on, all the rays go to the output pupil and no rays reflect back to the illumination beam pathway. In practice, the LCOS does not achieve perfect reflection, and some light will be incident on the photodiode. When powered on, roughly 10-50% of incident light is expected to reflect back to illumination module due to non-perfect reflectivity of the LCOS. In contrast, when the LCOS is off, roughly 90% or more of the light is reflected back to the illumination beam pathway and is incident on the photodiode.

At 1040, method 1000 includes, based on the readout of the one or more photodiodes while the LCOS panel is commanded to display a white frame, determining a reflectivity of the LCOS panel. In some examples, the reflectivity of the LCOS panel may be further and further based on the readout of the one or more photodiodes while the LCOS panel was commanded to display a black frame. Measuring the difference in optical power in the off state (e.g., black frame) and on state (e.g., white frame) allows for a determination of the reflectivity of the LCOS, which can change with temperature or time. For example, once LED power is calibrated based on reflectivity when the LCOS is powered off, LCOS performance can be calibrated when it is powered on. The amount of light incident on the LCOS panel can be determined based on the LED power calibration step independently of the wavelength of the LED.

At 1050, method 1000 includes adjusting the drive parameters of the LCOS panel based on the determined reflectivity. The determined reflectivity may allow for adjusting LCOS drive parameters to maximize the efficiency of the display, e.g., so as to optimally reflect light without wasting additional battery power.

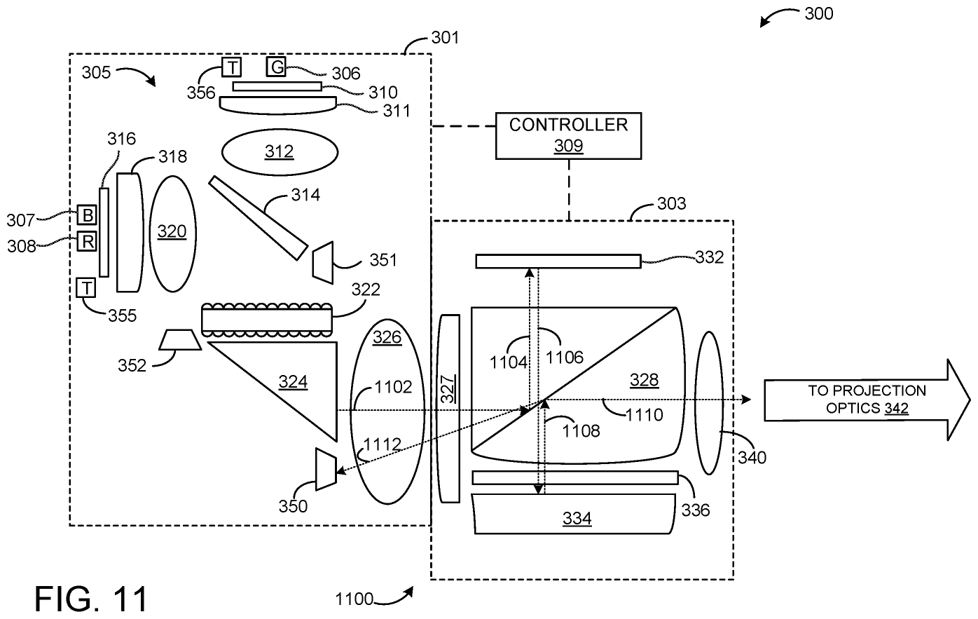

As an example, FIG. 11 shows an example scenario 1100 for display engine 300 when selectively reflective image forming device 332 is turned on. Light emitted from one or more optical source is combined in beam combiner 314, then directed to prism 324 via microlens array 322. As shown by arrow 1102, light emitted from prism 324 is directed to polarizing beam splitter 328 via lens 326 and pre-polarizer 327, where it is reflected towards selectively reflective image forming device 332, as shown by arrow 1104. As selectively reflective image forming device 332 is on, most of this light gets re-polarized. The re-polarized light passes through polarizing beam splitter 328 to mirror 334, as shown by arrow 1106. The light reflected off of mirror 334 is directed to quarter-wave panel 336, as shown by arrow 1108, and then directed to lens 340, as shown by arrow 1110. However, not all the light incident on selectively reflective image forming device 332 is re-polarized. Rather, some reflects off polarizing beam splitter 328 back to the illumination beam pathway, as shown by arrow 1112, where it may be captured by photodiode 350. With the output power of the optical sources determined as shown in FIG. 9, this readout may be used to determine the reflectivity of selectively reflective image forming device 332.

As described for systems with non-telecentric illumination, such as display engine 300, the reflected beam from the LCOS will have a slightly different angle compared to the illumination beam, and a photodiode can be placed so as not to conflict with the illumination beam pathway at all.

As such, the difference between reflectivity of the LCOS panel when powered off and powered on provides a true estimation of the reflectivity of the panel. As age, operating time and ambient temperature influence this reflectivity, the drive parameters may become sub-optimal due to drifting of LCOS performance. By measuring both the output power of the LEDs and the reflectivity of the LCOS panel, the drive parameters can be corrected based on operating conditions. A drop in reflectivity may be responded to with an increased drive power, for example. Adjusting the performance of the LEDs and the LCOS panel based on such measurements thus allows for control of both display brightness and output color accuracy.

In some embodiments, the methods and processes described herein may be tied to a computing system of one or more computing devices. In particular, such methods and processes may be implemented as a computer-application program or service, an application-programming interface (API), a library, and/or other computer-program product.

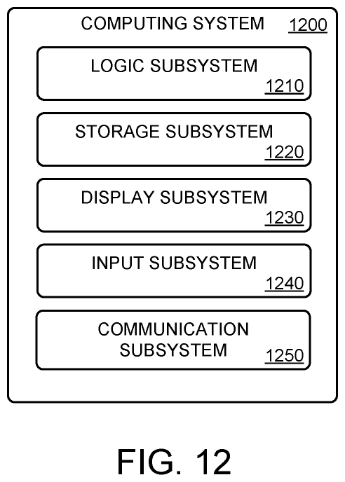

FIG. 12 schematically shows a non-limiting embodiment of a computing system 1200 that can enact one or more of the methods and processes described above. Computing system 1200 is shown in simplified form. Computing system 1200 may take the form of one or more personal computers, server computers, tablet computers, home-entertainment computers, network computing devices, gaming devices, mobile computing devices, mobile communication devices (e.g., smart phone), and/or other computing devices.

Computing system 1200 includes a logic machine 1210 and a storage machine 1220. Computing system 1200 may optionally include a display subsystem 1230, input subsystem 1240, communication subsystem 1250, and/or other components not shown in FIG. 12. Controllers 116, 215, 309, and 409 may be non-limiting examples of computing system 1200.

Logic machine 1210 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1220 includes one or more physical devices configured to hold instructions executable by the logic machine to implement the methods and processes described herein. When such methods and processes are implemented, the state of storage machine 1220 may be transformed—e.g., to hold different data.

Storage machine 1220 may include removable and/or built-in devices. Storage machine 1220 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1220 may include volatile, nonvolatile, dynamic, static, read/write, read-only, random-access, sequential-access, location-addressable, file-addressable, and/or content-addressable devices.

It will be appreciated that storage machine 1220 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1210 and storage machine 1220 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 implemented to perform a particular function. In some cases, a module, program, or engine may be instantiated via logic machine 1210 executing instructions held by storage machine 1220. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1230 may be used to present a visual representation of data held by storage machine 1220. This visual representation may take the form of a graphical user interface (GUI). As the herein described methods and processes change the data held by the storage machine, and thus transform the state of the storage machine, the state of display subsystem 1230 may likewise be transformed to visually represent changes in the underlying data. Display subsystem 1230 may include one or more display devices utilizing virtually any type of technology. Such display devices may be combined with logic machine 1210 and/or storage machine 1220 in a shared enclosure, or such display devices may be peripheral display devices.

When included, input subsystem 1240 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1250 may be configured to communicatively couple computing system 1200 with one or more other computing devices. Communication subsystem 1250 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the Internet.

In one example, a system for a display engine comprises an optical imaging pathway, comprising at least a selectively reflective image forming device; an illumination beam pathway, comprising an optical source cluster including one or more optical sources; optical componentry configured to generate uniform illumination of the selectively reflective image forming device; and one or more photodiodes positioned so as to capture light reflected off of the selectively reflective image forming device; and a controller configured to, for each optical source, command the selectively reflective image forming device to operate with a predetermined reflectivity; command the optical source to emit a pulse of light while the selectively reflective image forming device is operating with the predetermined reflectivity; read out the one or more photodiodes while the selectively reflective image forming device is operating with a predetermined reflectivity; and adjust a performance profile of one or more of the optical source and the selectively reflective image forming device based on the readout of the one or more photodiodes. In such an example, or any other example, commanding the selectively reflective image forming device to operate with a predetermined reflectivity additionally or alternatively includes commanding the selectively reflective image forming device to display a black frame, and wherein adjusting the performance profile additionally or alternatively includes adjusting an output power of the optical source. In any of the preceding examples, or any other example, the controller is additionally or alternatively configured to command the optical source to emit a pulse of light over a pattern of duty cycles; read out the one or more photodiodes for each duty cycle in the pattern of duty cycles; and adjust an output power of the optical source based on the readouts of the one or more photodiodes for each duty cycle in the pattern of duty cycles. In any of the preceding examples, or any other example, the controller is additionally or alternatively configured to command the optical source to emit a pulse of light over a range of current for a given duty cycle; read out the one or more photodiodes over the range of current for the given duty cycle; and adjust an output power of the optical source based on the readouts of the one or more photodiodes over the range of current for the given duty cycle. In any of the preceding examples, or any other example, commanding the selectively reflective image forming device to operate with a predetermined reflectivity additionally or alternatively includes commanding the selectively reflective image forming device to display a white frame, and wherein adjusting the performance profile additionally or alternatively includes adjusting drive parameters for the selectively reflective image forming device. In any of the preceding examples, or any other example, adjusting the drive parameters for the selectively reflective image forming device is additionally or alternatively based at least on the photodiode readout when the selectively reflective image forming device is commanded to display a white frame. In any of the preceding examples, or any other example, the one or more optical sources additionally or alternatively comprise one or more light emitting diodes. In any of the preceding examples, or any other example, the selectively reflective image forming device is additionally or alternatively a liquid-crystal-on-silicon panel. In any of the preceding examples, or any other example, the one or more photodiodes additionally or alternatively include two or more photodiodes with differing wavelength filters, and the controller is additionally or alternatively configured to determine a wavelength of each optical source based on a readout of the two or more photodiodes with differing wavelength filters when each optical source is commanded to emit a pulse of light. In any of the preceding examples, or any other example, the illumination beam pathway additionally or alternatively includes a fold mirror. In any of the preceding examples, or any other example, the one or more photodiodes are additionally or alternatively positioned optically behind the fold mirror. The technical effect of implementing this method is an increased power efficiency for a mobile device.

In another example, a method for calibrating a near-eye display device comprises, responsive to an indication to perform a first calibration step, command a liquid-crystal-on-silicon (LCOS) panel to display a white frame, the LCOS panel positioned within an optical imaging pathway; commanding one or more light-emitting diodes (LEDs) to emit a pulse of light while the LCOS panel is commanded to display a white frame, the LEDs positioned within an illumination beam pathway configured to generate uniform illumination of the LCOS panel; reading out one or more photodiodes positioned so as to capture light reflected off of the LCOS panel; based on the readout of the one or more photodiodes while the LCOS panel is commanded to display a white frame, determining a reflectivity of the LCOS panel; and adjusting the drive parameters of the LCOS panel based on the determined reflectivity. In such an example, or any other example, the method additionally or alternatively comprises, responsive to an indication to perform a second calibration step, commanding the LCOS panel to display a black frame, commanding the one or more LEDs to emit a pulse of light while the LCOS panel is commanded to display the black frame; reading out the one or more photodiodes; based on the readout of the one or more photodiodes while the LCOS panel is commanded to display the black frame, determining an optical power of the one or more LEDs; and adjusting the output power of the one or more LEDs based on the determined optical power. In any of the preceding examples, or any other example, the reflectivity of the LCOS panel is additionally or alternatively based on the readout of the one or more photodiodes while the LCOS panel was commanded to display the black frame. In any of the preceding examples, or any other example, the indication to perform the second calibration step additionally or alternatively includes instructions to perform the second calibration step during a warm-up phase of the near-eye display device. In any of the preceding examples, or any other example, the indication to perform the second calibration step additionally or alternatively includes instructions to perform the second calibration step in response to a threshold change in ambient temperature during an operation phase of the near-eye display device. In any of the preceding examples, or any other example, the indication to perform the second calibration step additionally or alternatively includes instructions to perform the second calibration step in response to exceeding a threshold runtime during operation of the near-eye display device. In any of the preceding examples, or any other example, the indication to perform the first calibration step additionally or alternatively includes instructions to perform the first calibration step in response to a threshold change in ambient temperature during operation of the near-eye display device. The technical effect of implementing this method is a reduction in consumption of battery resources.

In yet another example, a system for a display engine comprises an optical imaging pathway, comprising at least a selectively reflective image forming device; an illumination beam pathway, comprising an optical source cluster including one or more optical sources; optical componentry configured to generate uniform illumination of the selectively reflective image forming device; and one or more temperature sensors positioned in the optical source cluster; and a controller configured to, for each optical source: command the selectively reflective image forming device to operate with a predetermined reflectivity; command the optical source to emit a pulse of light while the selectively reflective image forming device is operating with the predetermined reflectivity; and determine a wavelength of each optical source based on a readout of the one or more temperature sensors when each optical source is commanded to emit a pulse of light. In such an example, or any other example, determining the wavelength of each optical source is additionally or alternatively based on a drive current of each optical source when commanded to emit a pulse of light, and the controller is additionally or alternatively configured to determine an optical power of the optical source based on the readout of the one or more temperature sensors and the drive current of each optical source when commanded to emit a pulse of light. The technical effect of implementing this system is an improvement in image quality of a display device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A system for a display engine, comprising:
an optical imaging pathway, comprising at least a selectively reflective image forming device;
an illumination beam pathway, comprising:
an optical source cluster including one or more optical sources;
optical componentry configured to generate uniform illumination of the selectively reflective image forming device; and
one or more photodiodes positioned so as to capture light reflected off of the selectively reflective image forming device; and
a controller configured to, for each optical source:
command the selectively reflective image forming device to operate with a predetermined reflectivity;
command the optical source to emit a pulse of light while the selectively reflective image forming device is operating with the predetermined reflectivity;
read out the one or more photodiodes while the selectively reflective image forming device is operating with a predetermined reflectivity; and
adjust a performance profile of one or more of the optical source and the selectively reflective image forming device based on the readout of the one or more photodiodes.

2. The system of claim 1, wherein commanding the selectively reflective image forming device to operate with a predetermined reflectivity includes commanding the selectively reflective image forming device to display a black frame, and wherein adjusting the performance profile includes adjusting an output power of the optical source.

3. The system of claim 2, wherein the controller is further configured to:
command the optical source to emit a pulse of light over a pattern of duty cycles;
read out the one or more photodiodes for each duty cycle in the pattern of duty cycles; and
adjust an output power of the optical source based on the readouts of the one or more photodiodes for each duty cycle in the pattern of duty cycles.

4. The system of claim 2, wherein the controller is further configured to:
command the optical source to emit a pulse of light over a range of current for a given duty cycle;
read out the one or more photodiodes over the range of current for the given duty cycle; and
adjust an output power of the optical source based on the readouts of the one or more photodiodes over the range of current for the given duty cycle.

5. The system of claim 2, wherein commanding the selectively reflective image forming device to operate with a predetermined reflectivity further includes commanding the selectively reflective image forming device to display a white frame, and wherein adjusting the performance profile includes adjusting drive parameters for the selectively reflective image forming device.

6. The system of claim 5, wherein adjusting the drive parameters for the selectively reflective image forming device is based at least on the photodiode readout when the selectively reflective image forming device is commanded to display a white frame.

7. The system of claim 1, wherein the one or more optical sources comprise one or more light emitting diodes.

8. The system of claim 1, wherein the selectively reflective image forming device is a liquid-crystal-on-silicon panel.

9. The system of claim 1, further comprising one or more temperature sensors positioned in the optical source cluster, and wherein the controller is further configured to determine a wavelength of each optical source based on a readout of the one or more temperature sensors when each optical source is commanded to emit a pulse of light.

10. The system of claim 1, wherein the illumination beam pathway includes a fold mirror.

11. The system of claim 10, wherein the one or more photodiodes are positioned optically behind the fold mirror.

12. A method for calibrating a near-eye display device, comprising:
responsive to an indication to perform a first calibration step,
commanding a liquid-crystal-on-silicon (LCOS) panel to display a white frame, the LCOS panel positioned within an optical imaging pathway;
commanding one or more light-emitting diodes (LEDs) to emit a pulse of light while the LCOS panel is commanded to display a white frame, the LEDs positioned within an illumination beam pathway configured to generate uniform illumination of the LCOS panel;
reading out one or more photodiodes positioned so as to capture light reflected off of the LCOS panel;
based on the readout of the one or more photodiodes while the LCOS panel is commanded to display a white frame, determining a reflectivity of the LCOS panel; and
adjusting the drive parameters of the LCOS panel based on the determined reflectivity.

13. The method of claim 12, further comprising:
responsive to an indication to perform a second calibration step,
commanding the LCOS panel to display a black frame,
commanding the one or more LEDs to emit a pulse of light while the LCOS panel is commanded to display the black frame;
reading out the one or more photodiodes;
based on the readout of the one or more photodiodes while the LCOS panel is commanded to display the black frame, determining an optical power of the one or more LEDs; and
adjusting the output power of the one or more LEDs based on the determined optical power.

14. The method of claim 13, wherein the reflectivity of the LCOS panel is further based on the readout of the one or more photodiodes while the LCOS panel was commanded to display the black frame.

15. The method of claim 13, wherein the indication to perform the second calibration step includes instructions to perform the second calibration step during a warm-up phase of the near-eye display device.

16. The method of claim 13, wherein the indication to perform the second calibration step includes instructions to perform the second calibration step in response to a threshold change in ambient temperature during an operation phase of the near-eye display device.

17. The method of claim 13, wherein the indication to perform the second calibration step includes instructions to perform the second calibration step in response to exceeding a threshold runtime during operation of the near-eye display device.

18. The method of claim 12, wherein the indication to perform the first calibration step includes instructions to perform the first calibration step in response to a threshold change in ambient temperature during operation of the near-eye display device.

19. A system for a display engine, comprising:
an optical imaging pathway, comprising at least a selectively reflective image forming device;
an illumination beam pathway, comprising:
an optical source cluster including one or more optical sources;
optical componentry configured to generate uniform illumination of the selectively reflective image forming device; and
one or more temperature sensors positioned in the optical source cluster; and
a controller configured to, for each optical source:
command the selectively reflective image forming device to operate with a predetermined reflectivity;
command the optical source to emit a pulse of light while the selectively reflective image forming device is operating with the predetermined reflectivity; and
determine a wavelength of each optical source based on a readout of the one or more temperature sensors when each optical source is commanded to emit a pulse of light.

20. The system of claim 19, wherein determining the wavelength of each optical source is further based on a drive current of each optical source when commanded to emit a pulse of light, and wherein the controller is further configured to determine an optical power of the optical source based on the readout of the one or more temperature sensors and the drive current of each optical source when commanded to emit a pulse of light.
